(19) United States
(12) Patent Application Publication
(10) Pub. No.: US 2025/0326158 A1
(43) Pub. Date: Oct. 23, 2025

(54) ROBOT DIAMOND SAW

(71) Applicant: EGUN CO., LTD., Gwangju-si (KR)

(72) Inventors: Sung Jun LEE, Gwangju-si (KR); Chae Mun LEE, Seongnam-si (KR)

(21) Appl. No.: 18/859,142

(22) PCT Filed: Apr. 14, 2023
(86) PCT No.: PCT/KR2023/005064

§ 371 Date: Oct. 22, 2024

(30) Foreign Application Priority Data
Apr. 25, 2022 (KR) 10-2022-0050768

(51) Int. Cl. B28D 1/04; B25J 9/14; B25J 11/00; B28D 1/08

(52) U.S. Cl. CPC B28D 1/045; B25J 9/144; B25J 11/0055; B28D 1/088

(57) ABSTRACT

A cutting robot according to the present invention comprises a main frame which is mounted to both sides of a vehicle body that can travel, so as to be able to ascend, descend, and rotate; a first hydraulic cylinder that is connected between the vehicle body and the main frame and rotates the main frame; a horizontal frame rotatably connected to the front end of the main frame; a second hydraulic cylinder that is connected between the main frame and the horizontal frame and rotates the horizontal frame; a cutting frame mounted to the upper surface of the horizontal frame so as to be able to rotate left and right; a third hydraulic cylinder that is connected between the horizontal frame and the cutting frame and rotates the cutting frame left and right; a cutting blade mounting part.

This application is a national phase entry of PCT Application No. PCT/KR2023/005064 filed on Apr. 14, 2023, which claims benefit and priority to Korean Patent Application No. 10-2022-0050768 filed on Apr. 25, 2022, both of which are incorporated by reference herein in their entirety.

### TECHNICAL FIELD

The present invention relates to a cutting robot, and more particularly, to a self-propelled cutting robot configured to cut a wall structure by changing the height of a cutting blade of the cutting robot, to cut a floor by rotating the cutting blade, to replace a currently installed cutting blade with a new cutting blade having a different size, and to provide a wire wheel mounted on a cutting rotation shaft of the cutting robot and adapted to rotate a wire saw.

### BACKGROUND ART

In general, a wall structure cutter, also referred to as a wall saw, is configured to cut a wall structure vertically erected from the floor using a rotating cutting blade. In the related art, a wall cutter is configured to cut a wall structure while moving along a guide rail fixedly installed along the wall surface. In this case, since a cutting blade of the wall cutter is rotated to cut a concrete wall structure, the guide rail needs to be stably fixed to the wall surface in order to support rotation of the cutting blade.

In this manner, the wall saw of the related art performs a cutting operation while moving along a predetermined path along the guide rail fixedly installed along the wall surface. Therefore, when the wall saw needs to perform a cutting operation while moving along a different path, it is required to remove the existing installed guide rail from the wall surface and to newly install the guide rail on a different path, leading to deterioration in efficiency of the cutting operation. For example, when a user wants to cut a wall structure having a different height at a different location, it is required to reinstall the guide rail. Accordingly, there is a problem in that the amount of work increases and it takes a lot of time.

Meanwhile, a floor cutter is configured to cut the floor surface by rotating a cutting blade that is erected perpendicular to the floor surface while moving along the floor surface. Conventionally, the cutting depth of the cutting blade is adjusted by rotating a frame having the cutting blade attached thereto in the upward-and-downward direction.

In the case of a conventional floor cutter, although the height of a cutting blade of the floor cutter is adjustable, the cutting angle of the cutting blade of the floor cutter is not adjustable because the angle of the cutting blade erected perpendicular to the floor surface is fixed. Further, it is also impossible to cut a wall structure using the floor cutter.

### DISCLOSURE

### Technical Problem

Therefore, the present invention has been made in view of the above problems, and it is an object of the present invention to provide a self-propelled cutting robot configured to cut a wall structure horizontally by changing the height of a cutting blade of the cutting robot, to cut a wall structure vertically or cut a floor by rotating the cutting blade, to replace a currently installed cutting blade with a new cutting blade having a different size, and to provide a wire wheel mounted on a cutting rotation shaft of the cutting robot and adapted to rotate a wire saw.

### Technical Solution

In accordance with the present invention, the above and other objects can be accomplished by the provision of a cutting robot including main frames respectively mounted on opposite sides of a self-propelled vehicle body, wherein the main frames are rotatably movable upwards and downwards on the vehicle body, first hydraulic cylinders configured to connect the vehicle body to the respective main frames so as to rotate the main frames, a horizontal frame rotatably connected to front ends of the main frames, second hydraulic cylinders configured to connect the main frames to the horizontal frame so as to rotate the horizontal frame, a cutting frame mounted on an upper surface of the horizontal frame and configured to be rotatable in a left-and-right direction, third hydraulic cylinders configured to connect the horizontal frame to the cutting frame so as to rotate the cutting frame in the left-and-right direction, a cutting blade mounting part mounted on a front end of the cutting frame and rotated around a horizontal rotation axis by an electric motor, and cutting blade detachably mounted on a cutting rotation shaft rotatably supported by the cutting blade mounting part, wherein the cutting blade is rotated by a hydraulic motor.

The main frames may be rotatably connected to respective upper ends of vehicle body frames respectively fixed to the opposite sides of the vehicle body, and the first hydraulic cylinders may connect respective middle portions of the vehicle body frames to respective middle portions of the main frames.

The second hydraulic cylinders may respectively connect connection frames fixed to respective middle portions of the main frames to vertical frame parts each fixed to an upper side of the horizontal frame, and the vertical frame parts each may have two or more connection portions respectively provided therein at different heights, wherein each of the second hydraulic cylinders may have a front end connected to any one of the connection portions.

The third hydraulic cylinders may respectively connect cylinder connection shafts respectively provided at rear ends of opposite sides of the horizontal frame to cylinder connection shafts respectively provided at opposite sides of an upper surface of the cutting frame.

The cutting blade mounting part may have a horizontal rotation shaft mounted on the front end of the cutting frame, and the electric motor may be mounted on an upper surface of the cutting frame and may be decelerated by two reducers so as to perform forward and reverse rotation of the horizontal rotation shaft.

The cutting robot may further include a cover detachably mounted on the cutting blade mounting part and configured to cover a half of one side of the cutting blade.

The cover may be rotatably mounted on the cutting blade mounting part, and a spring may connect a front end of the horizontal frame to one side of the cover, thereby enabling the spring to rotate the cover when the cutting frame is rotated.

The cover may include a main body part formed to have a semicircular disk shape, wherein the main body part may have an incised portion formed at a central portion thereof, and a curved cover part coupled to an outer circumferential surface of the main body part in a height adjustable manner.

The cutting robot may further include a wire wheel detachably mounted on the cutting rotation shaft and configured to rotate a wire saw, wherein the wire wheel is used instead of the cutting blade, and a roller guide mounted on the cutting blade mounting part and provided with two pairs of auxiliary rollers each configured to support the wire saw.

The cutting robot may further include a frame guide mounted on the upper surface of the horizontal frame so as to be rotatable in the left-and-right direction and configured to extendably and retractably support the cutting frame.

### Advantageous Effects

The present invention provides a self-propelled cutting robot configured to cut a wall structure horizontally by changing the height of a cutting blade of the cutting robot, to cut a wall structure vertically or cut a floor by rotating the cutting blade, to replace a currently installed cutting blade with a new cutting blade having a different size, and to provide a wire wheel mounted on a cutting rotation shaft of the cutting robot and adapted to rotate a wire saw.

### DESCRIPTION OF DRAWINGS

The above and other objects, features and other advantages of the present invention will be more clearly understood from the following detailed description taken in conjunction with the accompanying drawings, in which:

FIG. 1 is a side view of a cutting robot according to an embodiment of the present invention;

FIG. 2 is a front view of a vehicle body of the cutting robot;

FIG. 3 is a partial side view showing a state in which a main frame and a cutting blade are moved upwards;

FIG. 4 is a top view of the cutting robot;

FIG. 5 is a top view showing a state in which the cutting robot cuts a wall structure on the right side;

FIG. 6 is a top view showing a state in which the cutting robot cuts a wall structure on the left side;

FIG. 7 is a side view showing a state in which the cutting robot vertically cuts a wall structure in front of the cutting robot;

FIG. 8 is a top view showing a state in which a cover of a cutting blade is rotated by a spring when a cutting frame is rotated to the right;

FIG. 9 is a top view of the cover mounted on a front cutting blade mounting part of the cutting frame;

FIG. 10 is a cross-sectional view of the cutting blade and the cover;

FIG. 11 is a side view showing a state in which a wire wheel and a roller guide are mounted on the cutting blade mounting part;

FIG. 12 is a top view showing a state in which the cutting frame is mounted in a frame guide in an extendable and retractable manner, in which the frame guide is rotatably mounted on a horizontal frame; and

Part (a) of FIG. 13 is a top view showing a state in which a large cutting blade is mounted on the frame guide when the cutting frame extends, and part (b) of FIG. 13 is a top view showing a state in which a small cutting blade is mounted on the frame guide when the cutting frame retracts.

### BEST MODE

The present invention may be modified in various ways and may have various embodiments, and specific embodiments are illustrated in the drawings in detail in the detailed description. However, it should be understood that the present invention is not limited to the specific embodiments, and the specific embodiments include all modifications, equivalents, and substitutes that fall within the spirit and technical scope of the present invention.

Terms used in the present invention are only used to describe specific embodiments and are not intended to limit the present invention. In this specification, an expression in a singular form also includes the plural sense, unless clearly specified otherwise in context. It should be understood that expressions such as “comprise” and “have” in this specification are intended to designate the presence of indicated features, numbers, steps, operations, components, parts, or combinations thereof, but do not exclude the presence or addition of one or more features, numbers, steps, operations, components, parts, or combinations thereof.

Hereinafter, reference will now be made in detail to the preferred embodiments of the present invention, examples of which are illustrated in the accompanying drawings. Wherever possible, the same reference numbers will be used throughout the drawings to refer to the same or like parts, and redundant descriptions thereof will be omitted. In describing the embodiments disclosed herein, when it is determined that a detailed description of publicly known techniques to which the invention pertains may obscure the gist of the present invention, the detailed description will be omitted. Further, some omitted, or schematically components are exaggerated, shown in the accompanying drawings.

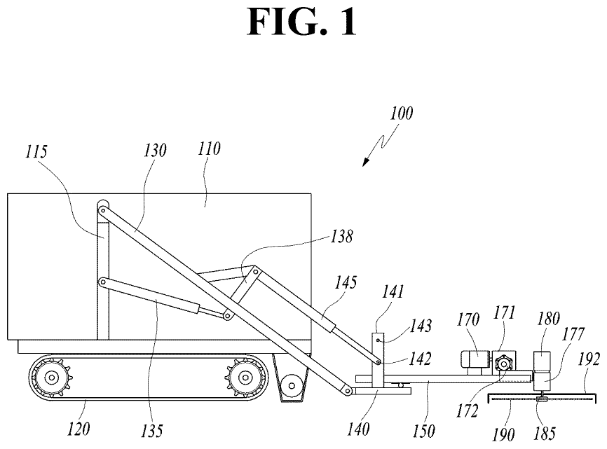

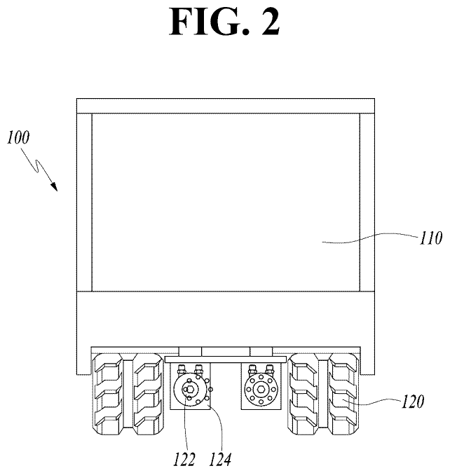

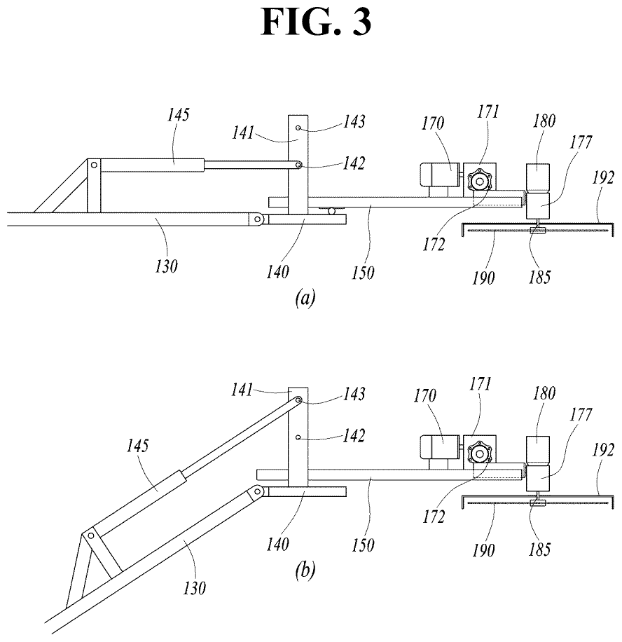

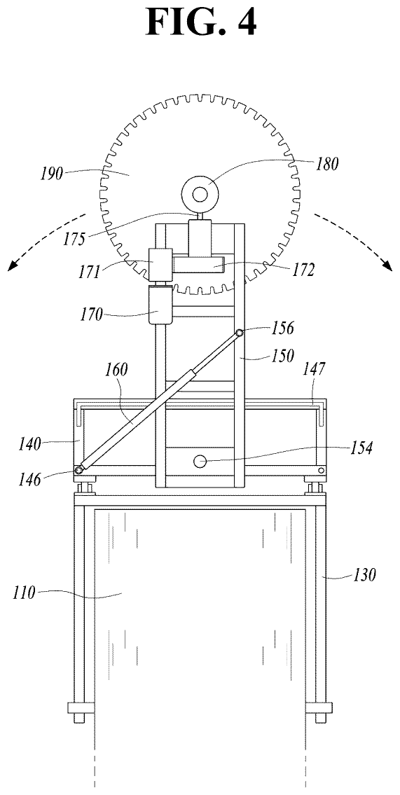

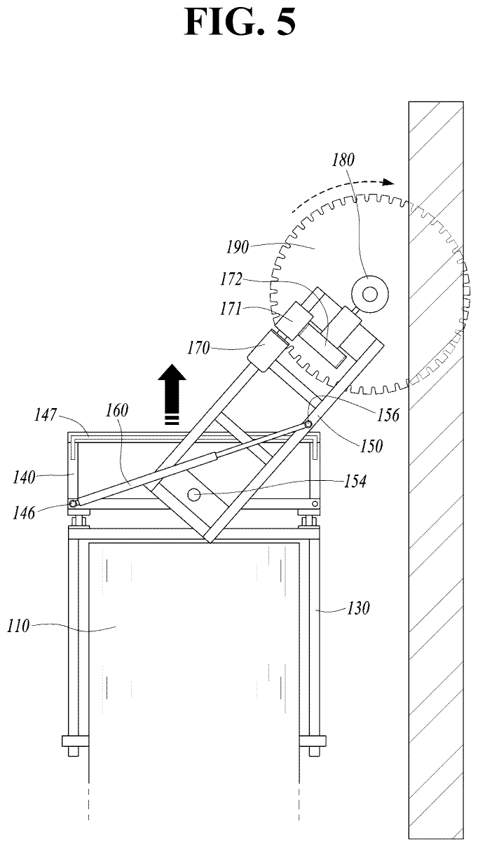

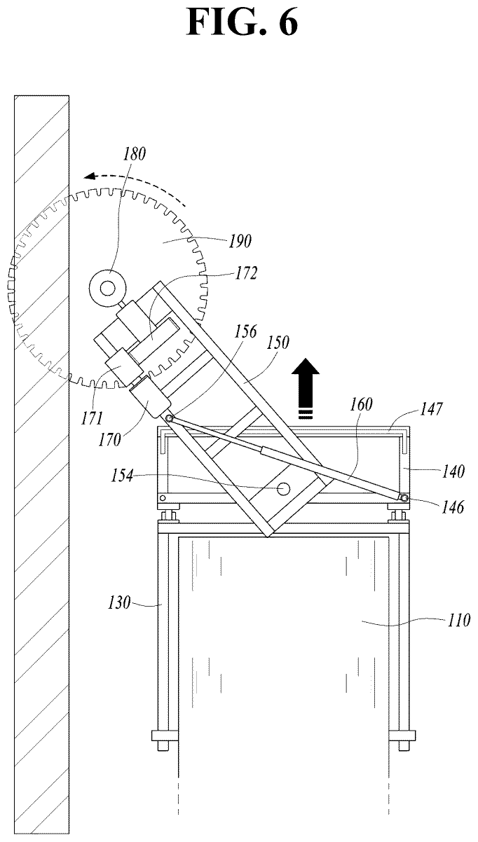

FIG. 1 is a side view of a cutting robot according to an embodiment of the present invention, FIG. 2 is a front view of a vehicle body of the cutting robot, FIG. 3 is a partial side view showing a state in which a main frame and a cutting blade are moved upwards, FIG. 4 is a top view of the cutting robot, FIG. 5 is a top view showing a state in which the cutting robot cuts a wall structure on the right side, and FIG. 6 is a top view showing a state in which the cutting robot cuts a wall structure on the left side.

A cutting robot 100 according to an embodiment of the present invention may cut a structure such as a concrete wall structure or a floor surface using a diamond saw. The cutting robot 100 may be provided with an engine and wheels or continuous tracks so as to be self-propelled along the floor surface.

The cutting robot 100 may include main frames 130 respectively mounted on opposite sides of a self-propelled vehicle body 110, in which the main frames are rotatably movable upwards and downwards on the vehicle body, first hydraulic cylinders 135 configured to connect the vehicle body to the respective main frames so as to rotate the main frames, a horizontal frame 140 rotatably connected to the front ends of the main frames, second hydraulic cylinders 145 configured to connect the main frames to the horizontal frame so as to rotate the horizontal frame, a cutting frame 150 mounted on the upper surface of the horizontal frame and configured to be rotatable left-and-right direction, third hydraulic cylinders 160 each configured to connect the horizontal frame to the cutting frame so as to rotate the cutting frame in the left-and-right direction, a cutting blade mounting part 177 mounted on the front end of the cutting frame and rotated around a horizontal rotation axis by an electric motor 170, and a cutting blade 190 detachably mounted on a cutting rotation shaft 185 rotatably supported by the cutting blade mounting part, in which the cutting blade is rotated by a hydraulic motor 180.

As shown in FIG. 1, the vehicle body 110 may be formed to have an approximately rectangular parallelepiped shape. The vehicle body 110 may have two pairs of wheels (four wheels), three wheels, or a pair of continuous tracks 120 respectively provided on opposite sides of a lower portion thereof so as to be self-propelled along the floor surface. When four wheels are provided in the vehicle body, the cutting robot may be configured as a front-wheel drive vehicle or a rear-wheel drive vehicle, and the rear wheels or the front wheels may be configured as steering wheels of the vehicle body. When three wheels are provided in the vehicle body, the cutting robot may be configured as a rear-wheel drive vehicle, and the rear wheel may be configured as a steering wheel.

The vehicle body 110 may have an engine or a motor installed at the inside thereof and configured to drive the continuous tracks 120. As shown in FIG. 2, a pair of hydraulic motors 122 and a pair of reducers 124 may be connected to a front drive shaft of the pair of continuous tracks 120. Instead of the hydraulic motor 122, an electric motor or an engine may be used to perform forward or reverse rotation of wheels or continuous tracks. Since the reducer is connected to the motor, the vehicle body 110 may be precisely moved during cutting operation.

The main frames 130 may be respectively provided on the upper ends of the opposite sides of the vehicle body 110 so as to be rotatably moved upwards and downwards. Each of the main frames 130 is formed to have a longer length than a diagonal length of the side surface of the vehicle body 110. Here, a connection frame may be provided to connect the inner surfaces of the front ends of the two main frames 130 to each other, thereby reinforcing strength of the main frames.

The main frames 130 may be directly mounted on the vehicle body 110 or may be rotatably connected to the respective upper ends of vehicle body frames 115 respectively fixed to the opposite sides of the vehicle body 110. The vehicle body frames 115 may be vertically mounted on and fixed to the opposite sides of the vehicle body 110, and the main frames 130 may be respectively connected to the upper ends of the vehicle body frames 115 so as to be rotatably moved upwards and downwards.

The first hydraulic cylinders 135 may respectively connect the vehicle body frames 115 to the main frames 130 so as to rotatably move the main frames 130 upwards and downwards relative to the vehicle body frames 115. Specifically, the opposite ends of each of the first hydraulic cylinders 135 may be rotatably connected to a middle portion of a corresponding one of the vehicle body frames 115 and a middle portion of a corresponding one of the main frames 130, respectively.

The horizontal frame 140 may be vertically rotatably connected to the front end of the main frames 130. The horizontal frame 140 may be formed to have a rectangular shape, the outline of which is long in the left-and-right direction. The horizontal frame 140 may be connected to the front ends of the pair of main frames 130 so as to be movable upwards and downwards by a pair of horizontal connection shafts.

The second hydraulic cylinders 145 may respectively connect the main frames 130 to the horizontal frame 140 so as to rotate the horizontal frame 140. The second hydraulic cylinder 145 may constantly maintain a parallel state of the horizontal frame 140 relative to the floor surface when the main frames 130 are moved upwards or downwards.

The second hydraulic cylinders 145 may respectively connect connection frames 138 fixed to respective middle portions of the main frames 130 to vertical frame parts 141 each fixed to the upper side of the horizontal frame 140. The connection frames 138 may be respectively welded and coupled to the middle portions of the upper surfaces of the pair of main frames 130, and one end of each of the second hydraulic cylinders 145 may be connected to the upper end of a corresponding one of the connection frames 138 so as to be rotatable about a horizontal axis.

The vertical frame parts 141 may be respectively coupled to opposite sides of the upper surface of the horizontal frame 140 by being vertically welded or fastened to the opposite sides. Each of the vertical frame parts 141 may have two or more connection portions respectively provided therein at different heights. Here, each of the second hydraulic cylinders 145 has a front end connected to any one of the connection portions. That is, each of the vertical frame parts 141 may include a first connection portion 142 formed to penetrate a lower portion of a corresponding one of the vertical frame parts 141 in the left-and-right direction, and a second connection portion 143 formed to penetrate an upper portion of a corresponding one of the vertical frame parts 141 in the left-and-right direction.

As shown in FIG. 1 and part (a) of FIG. 3, when the main frames 130 are rotated downwards or are horizontally disposed, the front end portions of the second hydraulic cylinders 145 may be respectively connected to the first connection portions 142. As shown in part (b) of FIG. 3, when the main frames 130 are rotated upwards, the front end portions of the second hydraulic cylinders 145 may be respectively connected to the second connection portions 143. The reason for this is that, when the main frames 130 are rotated upwards, the second hydraulic cylinders 145 may interfere with connection portions respectively connecting the main frames 130 to the horizontal frame 140.

The cutting frame 150 may be mounted on the upper surface of the horizontal frame 140 so as to be rotatable in the left-and-right direction. To this end, a rotation shaft 154 provided close to the rear end of the cutting frame 150 may be mounted on a rotation shaft provided at a central portion of the horizontal frame 140 in the left-and-right direction. The cutting frame 150 may be formed to have a rectangular shape, the outline of which is long overall in the forward-and-rearward direction. The rotation shaft 154 may be formed to be integrated with a bracket welded to the inside of the cutting frame 150.

The horizontal frame 140 may have a support rib 147 provided on the upper surface thereof and configured to allow the cutting frame 150 to be slidably movable. At least an upper portion of the support rib 147 may be formed to have an arc-shaped cross section so as to reduce frictional force between the horizontal frame 140 and the cutting frame 150 that rotates in the left-and-right direction and to reliably support smooth rotation of the cutting frame 150.

The third hydraulic cylinders 160 may connect the horizontal frame 140 to the cutting: frame 150 so as to rotate the cutting frame 150 in the left-and-right direction. To this end, a pair of cylinder connection shafts 146 may be provided vertically on the upper surface of the horizontal frame 140 near the vertices of the rear ends of opposite sides of the horizontal frame 140, and a pair of cylinder connection shafts 156 may be provided on opposite sides of the upper surface of the cutting frame 150.

As shown in FIG. 5, when the cutting frame 150 is rotatably moved to the right side, the third hydraulic cylinders 160 may respectively connect the left cylinder connection shafts 146 of the horizontal frame 140 to the right cylinder connection shafts 156 of the cutting frame 150. In this state, the third hydraulic cylinders 160 may be operated to extend.

As shown in FIG. 6, when the cutting frame 150 is rotatably moved to the left side, the third hydraulic cylinders 160 may respectively connect the right cylinder connection shafts 146 of the horizontal frame 140 to the left cylinder connection shafts 156 of the cutting frame 150. In this state, the third hydraulic cylinder 160 may be operated to extend.

The cutting blade mounting part 177 may be mounted on the front end of the cutting frame 150 so as to be rotated around a horizontal rotation shaft 175 by the electric motor 170. The horizontal rotation shaft 175 may be inserted into a bearing provided at the upper end of the front end of the cutting frame 150 so as to be rotatably mounted on the cutting frame. The electric motor 170 may be mounted on one side of the first half of the upper surface of the cutting frame 150 so as to rotate the horizontal rotation shaft 175. The cutting blade mounting part 177 may be welded or coupled to the horizontal rotation shaft 175 so as to be rotated in conjunction with rotation of the horizontal rotation shaft 175.

The cutting blade 190 may be detachably mounted on the lower end of the cutting blade mounting part 177 and may be rotated by the hydraulic motor 180. The hydraulic motor 180 may be coupled to an upper portion of the cutting blade mounting part 177, and hydraulic hoses from a hydraulic pump provided in the vehicle body 110 may be connected to the hydraulic motor 180.

The electric motor 170 may be mounted on the upper surface of the cutting frame 150 and may be decelerated by two reducers so as to perform forward and reverse rotation of the horizontal rotation shaft 175. A drive shaft of the electric motor 170 may be connected to a first reducer 171 mounted on one side of the upper surface of the cutting frame 150 in the vertical direction, and a rotation shaft of the first reducer 171 may be connected to a second reducer 172 mounted on the upper surface of the cutting frame 150 in the horizontal direction.

The first reducer 171 and the second reducer 172 may include a plurality of spur gears, bevel gears, worm gears, and the like. The two reducers are provided between the electric motor 170 and the horizontal rotation shaft 175, thereby making it possible to precisely rotate the horizontal rotation shaft 175 with a large torque.

The cutting rotation shaft 185 may be rotatably inserted into and mounted on the cutting blade mounting part 177. The upper end of the cutting rotation shaft 185 may be coupled to the hydraulic motor 180, and the cutting blade 190 may be detachably coupled to the lower end of the cutting rotation shaft 185.

The cutting blade 190 may have, as a diamond saw, a plurality of teeth formed around the circumferential edge of a circular disk and made of a material including diamond. Therefore, the cutting blade 190 may cut a reinforced concrete structure or rock while rotating.

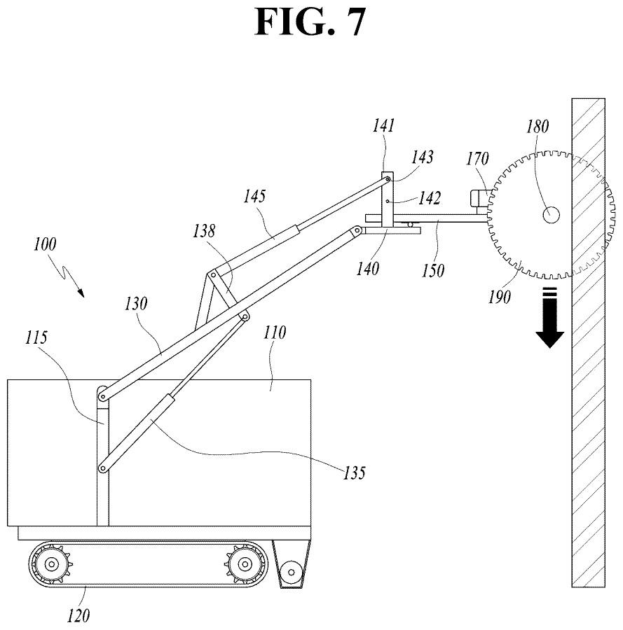

FIG. 7 is a side view showing a state in which the cutting robot vertically cuts a wall structure in front of the cutting robot.

When the cutting robot 100 cuts the wall structure vertically, that is, from a top portion of the wall structure to a bottom portion thereof, the front ends of the second hydraulic cylinders 145 may be respectively connected to the second connection portions 143 so as to rotate the respective main frames 130 upwards. In this case, the electric motor 170 is operated to rotate the horizontal rotation shaft 175 and to vertically dispose the cutting blade 190, and then the hydraulic motor 180 is operated to rotate the cutting blade 190, thereby cutting the wall structure in the vertical direction. When the wall structure is vertically cut, the first hydraulic cylinders 135 and the second hydraulic cylinders 145 may be operated to slowly move the cutting frame 150 downwards, and simultaneously, the continuous tracks 120 are operated to slowly move the vehicle body 110 rearwards.

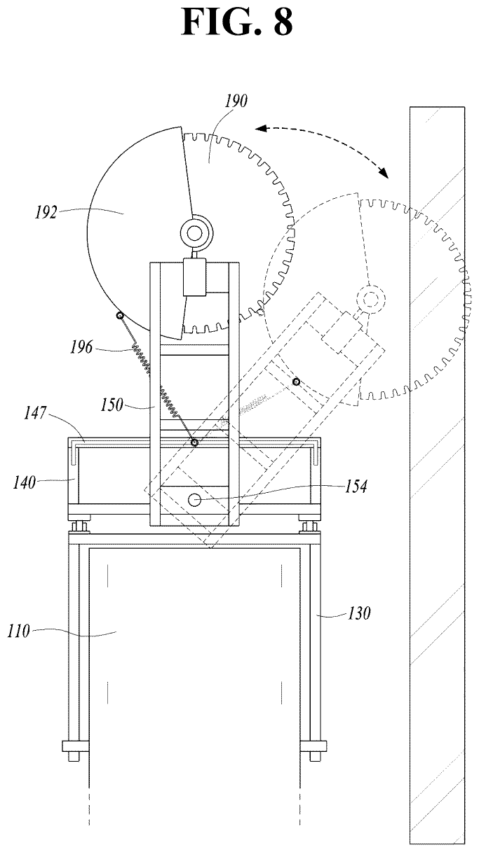

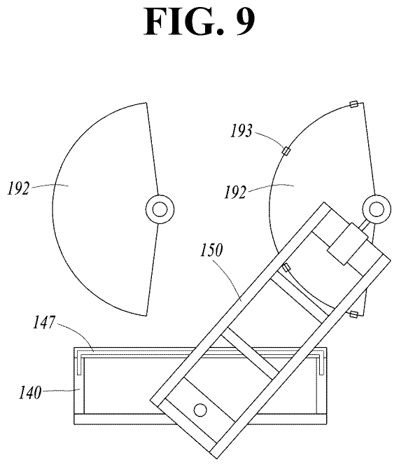

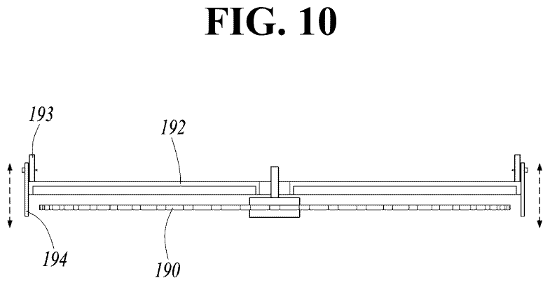

FIG. 8 is a top view showing a state in which a cover of the cutting blade is rotated by a spring when the cutting frame is rotated to the right side, FIG. 9 is a top view of the cover mounted on a front cutting blade mounting part of the cutting frame, and FIG. 10 is a longitudinal cross-sectional view of the cutting blade and the cover.

The cutting robot 100 may further include a cover 192 detachably mounted on the cutting blade mounting part 177 and configured to cover a half of one side of the cutting blade 190. The cover 192 may be formed to cover an upper portion of a half of one side of the cutting blade 190 and the outer circumferential surface thereof.

The cover 192 is rotatably mounted on the cutting blade mounting part 177, and a spring 196 connects the front end of the horizontal frame 140 to one side of the cover 192. In this manner, when the cutting frame 150 is rotated, the spring 196 may rotate the cover 192.

The cover 192 may be detachably and rotatably mounted on the lower end of the cutting blade mounting part 177. The spring 196 may have one end connected to the central portion of the front end of the horizontal frame 140 and the other end connected to one side of the outer surface of the cover 192.

As shown in FIG. 8, the length, elastic force, and connection position of the spring 196 are appropriately adjusted between the front end of the horizontal frame 140 and one side of the cover 192. In this manner, when the cutting frame 150 is rotated in the left-and-right direction, the spring 196 may rotate the cover 192, and the straight line passing through a central portion of the cover 192 may be disposed parallel to the wall structure.

As shown in FIGS. 9 and 10, the cover 192 may include a main body part formed to have a semicircular disk shape, in which the main body part has an incised portion formed at a central portion thereof, and a curved cover part 194 coupled to the outer circumferential surface of the main body part in a height adjustable manner.

The curved cover part 194 may have a curved band shape such that the curved cover part is coupled to the outer circumferential surface of the main body part in a state of being spaced apart therefrom by a predetermined distance. Since the curved cover part 194 is mounted on the main body part of the cover 192 in a height adjustable manner, the curved cover part 194 may be disposed closer to the wall surface. In order to adjust the height of the curved cover part 194, a plurality of height adjustment ribs 193 may be provided on the side arc surface of the main body part of the cover 192. Since a long hole is formed in at least one side of the height adjustment rib 193 and the curved cover part 194, the curved cover part 194 may be coupled to the height adjustment rib 193 by adjusting the height of the height adjustment rib 193 using a bolt and a nut.

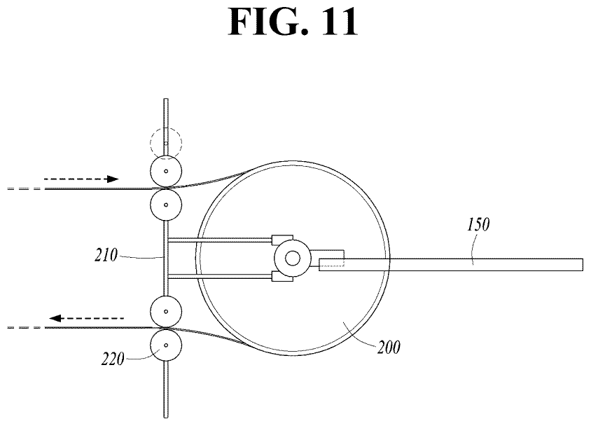

FIG. 11 is a side view showing a state in which a wire wheel and a roller guide are mounted on the cutting blade mounting part.

As shown in FIG. 11, the cutting robot 100 may further include a wire wheel 200 detachably mounted on the cutting rotation shaft 185 and configured to rotate a wire saw, in which the wire wheel is used instead of the cutting blade 190, and a roller guide 210 mounted on the cutting blade mounting part 177 and provided with two pairs of auxiliary rollers 220 each configured to support the wire saw.

The roller guide 210 may separate and couple the cutting blade 190 from and to the cutting rotation shaft 185 rotatably supported by the cutting blade mounting part 177. The roller guide 210 formed in a circular disk shape having a predetermined thickness may have a groove formed on the outer circumferential surface thereof and configured allow the wire saw to be inserted thereinto.

The roller guide 210 may be coupled to the cutting blade mounting portion 177 fastening a plurality of screws. The roller guide 210 may include two vertical bars coupled to the cutting blade mounting part 177, and a horizontal bar having the two pairs of auxiliary rollers 220 respectively mounted on opposite sides thereof, in which the horizontal bar is welded to the two vertical bars. The auxiliary rollers 220 may be formed in pairs to guide and support the wire saw passing therebetween, thereby preventing deviation of the wire saw.

In the present embodiment, instead of the cutting blade 190, the wire wheel 200 and the roller guide 210 may be combined with each other to rotate the wire saw, and a structure may be cut by rotation of the wire saw.

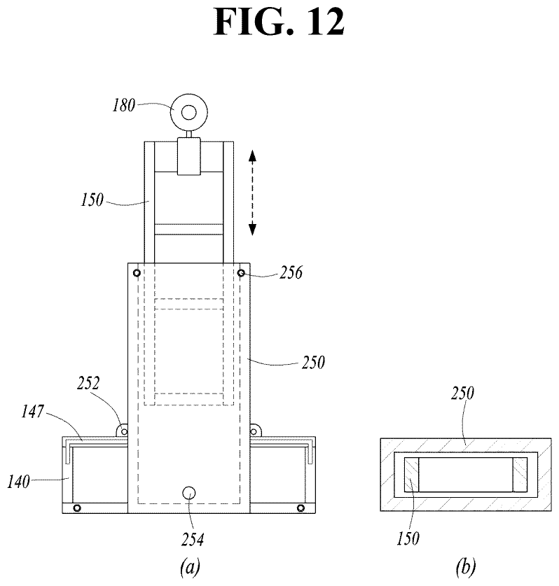

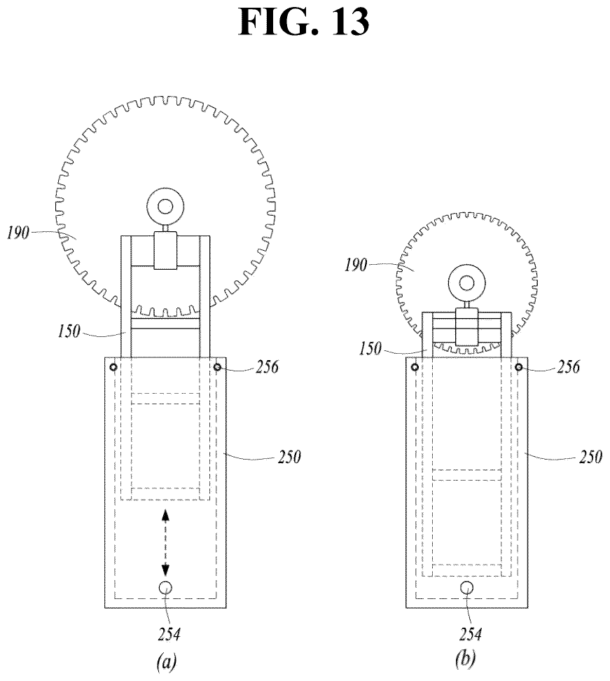

FIG. 12 is a top view showing a state in which the cutting frame is mounted in a frame guide in an extendable and retractable manner, in which the frame guide is rotatably mounted on the horizontal frame, and part (a) of FIG. 13 is a top view showing a state in which a large cutting blade is mounted on the frame guide when the cutting frame extends, and part (b) of FIG. 13 is a top view showing a state in which a small cutting blade is mounted on the frame guide when the cutting frame retracts.

As shown in FIG. 12, the cutting robot 100 may further include a frame guide 250 mounted on the upper surface of the horizontal frame 140 so as to be rotatable in the left-and-right direction and configured to support the cutting frame 150 such that the cutting frame 150 is extendable and retractable in the frame guide.

The frame guide 250 may be mounted between the horizontal frame 140 and the cutting frame 150 so as to support the cutting frame 150 in an extendable and retractable manner. In the previous embodiment, the cutting frame 150 is mounted directly on t upper surface of the horizontal frame 140, whereas, in this embodiment, the frame guide 250 may be mounted on the upper surface of the horizontal frame 140 so as to be rotatable in the left-and-right direction, and the cutting frame 150 may be inserted into the frame guide 250 in an extendable and retractable manner.

The frame guide 250 may be formed to have a rectangular pipe shape in cross section so as to enable the cutting frame 150 to be slidably inserted thereinto. The frame guide 250 may have a rotation shaft 254 provided at the rear end thereof and rotatably mounted on the upper surface of the horizontal frame 140.

The frame guide 250 may have a pair of cylinder connection parts 256 provided on opposite sides of the upper surface thereof. In this manner, the third hydraulic cylinders 160 may connect the horizontal frame 140 to the frame guide 250. Therefore, when the third hydraulic cylinders 160 rotate the frame guide 250 in the left-and-right direction on the horizontal frame 140, the cutting frame 150 may be rotated in conjunction with rotation of the frame guide.

In addition, the horizontal frame 140 may have a pair of brackets provided on opposite sides of the front side thereof and configured to respectively fasten a pair of fixing bolts 252 thereto. When the cutting robot 100 is simply moved without performing a cutting operation, the pair of fixing bolts 252 may be respectively fastened to the pair of brackets provided on the horizontal frame so as to fix the frame guide 250. In this manner, the frame guide 250 may not be rotated in the left-and-right direction.

As shown in part (a) of FIG. 13, when a cutting blade 190 having a large diameter is mounted on the frame guide, the cutting frame 150 may extend into the frame guide 250 and may be fixed therein.

As shown in part (b) of FIG. 13, when the cutting blade 190 having a small diameter is mounted on the frame guide, the cutting frame 150 may be retracted by being inserted into the frame guide 250 and may be fixed therein.

As described above, in the present embodiment, the cutting frame may be rotated in the left-and-right direction, and the cutting frame may be mounted in the frame guide in an extendable and retractable manner, thereby making it possible to reliably respond to a change in size of the cutting blade by appropriately adjusting a distance between the rotation axis and the cutting rotation axis.

Although preferred embodiments of the present invention have been disclosed for illustrative purposes, those skilled in the art will appreciate that the present invention may be modified and changed in various ways by adding, changing, deleting, or adding components, without departing from the scope and spirit of the present invention as disclosed in the accompanying claims. Further, it is noted that such modifications and variations are intended to be included within the scope of the present invention.

### DESCRIPTION OF REFERENCE NUMERALS

100: Cutting robot
110: Vehicle body 115: Vehicle body frame 120: Continuous tracks 122: Hydraulic motor 124: Reducer
130: Main frame 135: First hydraulic cylinder 138: Connection frame 140: Horizontal frame
141: Vertical frame part 142: First connection part 143: Second connection part 145: Second hydraulic cylinder
146: Cylinder connection shaft 147: Support rib 150: Cutting frame 154: Rotation shaft
156: Cylinder connection shaft 160: Third hydraulic cylinder 170: Electric motor 171: First reducer
172: Second reducer 175: Horizontal rotation shaft 177: Cutting blade mounting part 180: Hydraulic motor
185: Cutting rotation shaft 190: Cutting blade 192: Cover 193: Height adjustment rib
194: Curved cover part 196: Spring
200: Wire wheel 210: Roller guide 220: Auxiliary roller 250: Frame guide
252: Guide fixing bolt 254: Rotation shaft 256: Cylinder connection part

### INDUSTRIAL APPLICABILITY

A self-propelled cutting robot apparatus may be equipped with a wire wheel configured to rotate a wire saw and may be industrially usable in an industrial site at which cutting work of a structure is performed.

1. A cutting robot comprising:
main frames respectively mounted on opposite sides of a self-propelled vehicle body, wherein the main frames are rotatably movable upwards and downwards on the vehicle body;
first hydraulic cylinders configured to connect the vehicle body to the respective main frames so as to rotate the main frames;
a horizontal frame rotatably connected to front ends of the main frames;
second hydraulic cylinders configured to connect the main frames to the horizontal frame so as to rotate the horizontal frame;
a cutting frame mounted on an upper surface of the horizontal frame and configured to be rotatable in a left-and-right direction;
third hydraulic cylinders each configured to connect the horizontal frame to the cutting frame so as to rotate the cutting frame in the left-and-right direction;
a cutting blade mounting part mounted on a front end of the cutting frame and rotated around a horizontal rotation axis by an electric motor; and
a cutting blade detachably mounted on a cutting rotation shaft rotatably supported by the cutting blade mounting part, wherein the cutting blade is rotated by a hydraulic motor.

2. The cutting robot according to claim 1, wherein:
the main frames are rotatably connected to respective upper ends of vehicle body frames respectively fixed to the opposite sides of the vehicle body, and
the first hydraulic cylinders connect respective middle portions of the vehicle body frames to respective middle portions of the main frames.

3. The cutting robot according to claim 1, wherein:
the second hydraulic cylinders respectively connect connection frames fixed to respective middle portions of the main frames to vertical frame parts each fixed to an upper side of the horizontal frame, and
the vertical frame parts each have two or more connection portions respectively provided therein at different heights, wherein each of the second hydraulic cylinders has a front end connected to any one of the connection portions.

4. The cutting robot according to claim 1, wherein the third hydraulic cylinders respectively connect cylinder connection shafts respectively provided at rear ends of opposite sides of the horizontal frame to cylinder connection shafts respectively provided at opposite sides of an upper surface of the cutting frame.

5. The cutting robot according to claim 1, wherein:
the cutting blade mounting part has a horizontal rotation shaft mounted on the front end of the cutting frame, and
the electric motor is mounted on an upper surface of the cutting frame and is decelerated by two reducers so as to perform forward and reverse rotation of the horizontal rotation shaft.

6. The cutting robot according to claim 1, further comprising a cover detachably mounted on the cutting blade mounting part and configured to cover a half of one side of the cutting blade.

7. The cutting robot according to claim 6, wherein:
the cover is rotatably mounted on the cutting blade mounting part, and
a spring connects a front end of the horizontal frame to one side of the cover, thereby enabling the spring to rotate the cover when the cutting frame is rotated.

8. The cutting robot according to claim 6, wherein the cover comprises:
a main body part formed to have a semicircular disk shape, wherein the main body part has an incised portion formed at a central portion thereof; and
a curved cover part coupled to an outer circumferential surface of the main body part in a height adjustable manner.

9. The cutting robot according to claim 1, further comprising:
a wire wheel detachably mounted on the cutting rotation shaft and configured to rotate a wire saw, wherein the wire wheel is used instead of the cutting blade; and
a roller guide mounted on the cutting blade mounting part and provided with two pairs of auxiliary rollers each configured to support the wire saw.

10. The cutting robot according to claim 1, further comprising a frame guide mounted on the upper surface of the horizontal frame so as to be rotatable in the left-and-right direction and configured to extendably and retractably support the cutting frame.
